(19) United States
(12) Patent Application Publication
(10) Pub. No.: US 2014/0339206 A1
(43) Pub. Date: Nov. 20, 2014

(54) REMELTING METHOD AND SUBSEQUENT REFILLING AND COMPONENT

(71) Applicants: Michael Ott, Mulheim an der Ruhr (DE); Sebastian Piegert, Berlin (DE); Ingo Reinkensmeier, Frondenberg (DE)

(72) Inventors: Michael Ott, Mulheim an der Ruhr (DE); Sebastian Piegert, Berlin (DE); Ingo Reinkensmeier, Frondenberg (DE)

(73) Assignee: SIEMENS AKTIENGESELLSCHAFT, München (DE)

(21) Appl. No.: 14/354,228

(22) PCT Filed: Sep. 14, 2012
(86) PCT No.: PCT/EP2012/068054

§ 371 Date: Apr. 25, 2014

(30) Foreign Application Priority Data
Nov. 11, 2011 (EP) 11188750

(51) Int. Cl. B23P 6/00; B23K 26/34

(52) U.S. Cl. CPC B23P 6/007; B23K 26/345
USPC 219/121.66; 29/402.18; 219/76.1

(57) ABSTRACT

A method for re-melting and refilling a defect (7) in a surface (19) of a substrate (4) by re-melting the defect (7) causing a hollow (28) to be produced above the re-melt, and the hollow (28) is refilled. A nickel- or cobalt-based substrate (4) is re-melted by a laser re-melting method. Subsequently, the hollow (28) that is produced is refilled by a laser application method, in particular by soldering. Also, a component having a re-melted region (25) and a solder region (31) thereover is disclosed.

### CROSS-REFERENCE TO RELATED APPLICATIONS

The present application is a 35 U.S.C. §§371 national phase conversion of PCT/EP2012/068054, filed Sep. 14, 2012, which claims priority of European Application No. 11188750.1 filed Nov. 11, 2011, the contents of which are incorporated by reference herein. The PCT International Application was published in the German language

The invention relates to a re-melting process, which removes impurities from the zone to be re-melted, and subsequent filling and also to a component.

### TECHNICAL BACKGROUND

High-temperature components, e.g. turbine blades or vanes, which have been in operation for a long period of time sometimes have cracks which pass through the layers as the component as far as into the substrate, where they oxidize.

In order to re-use the turbine blades or vanes, the cracks have to be re-filled.

Beforehand, however, the oxides are removed, since otherwise no wetting with the welding material can take place. Therefore, cleaning is performed with fluoride gas (FIC cleaning) in a separate process before the welding. This constitutes a separate process step and is therefore time-consuming.

### SUMMARY OF THE INVENTION

It is therefore an object of the invention to solve the problem mentioned above.

The object is achieved by a process and a component of the invention.

### BRIEF DESCRIPTION OF THE DRAWINGS

FIGS. 1-4 schematically show an apparatus which can be used to carry out the process,

FIG. 5 shows a turbine blade or vane, and

FIG. 6 shows a list of superalloys.

### DESCRIPTION OF EMBODIMENTS

The description and the figures represent merely exemplary embodiments of the invention.

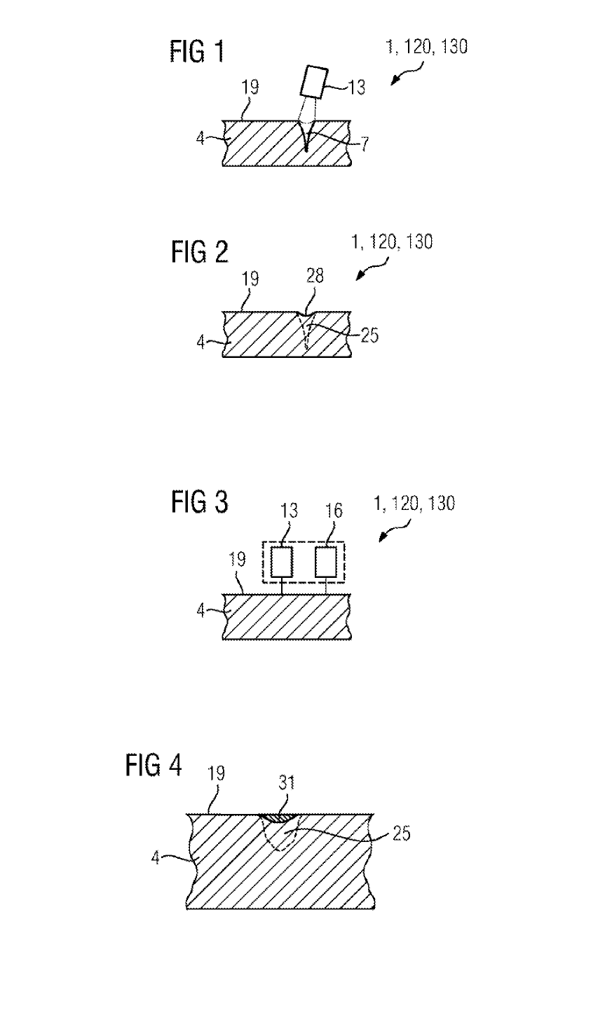

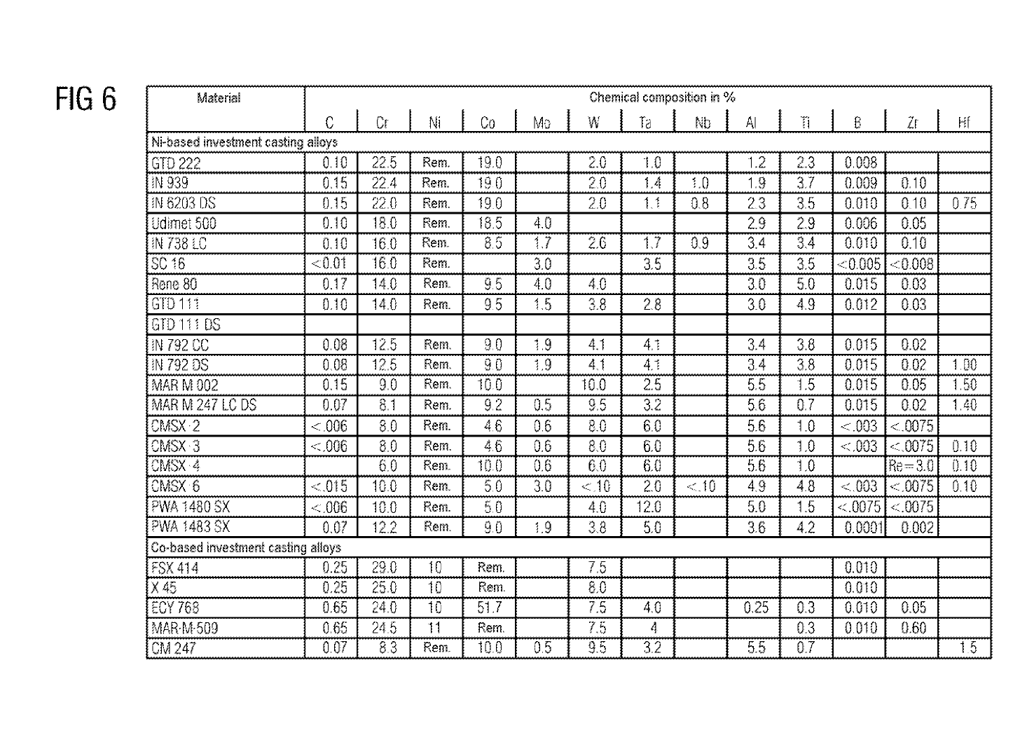

FIG. 1 shows a component 1, 120, 130 having a substrate 4. The substrate 4 is in particular based on nickel or cobalt and very particularly comprises an alloy as shown in FIG. 6. The substrate 4 has a crack 7 (defect), in which oxides are present (oxides not shown).

This crack 7 should now be repaired, i.e. filled or closed.

To this end, in a first step, the substrate 4 is re-melted in the region of the crack 7 by means of a welding appliance, in particular a laser 13 and a laser beam, on the basis of which the invention will be explained by way of example (i.e. without the supply of material).

In the process, it is preferable that the laser 13 moves along the crack 7 (here perpendicular to the plane of the drawing).

It is preferable that a shielding gas nozzle envelops the laser beam in order to prevent oxygen ingress (<150 ppm oxygen) to the molten pool.

The re-melting process often forms a depression 28 in the region of the surface 19 of the substrate 4, as shown in FIG. 2. A re-melting region 25 has formed under the depression 28.

In a second step, the depression 28 is then filled with material, giving rise to a filling region 31 shown in FIG. 4.

This can be effected by known soldering or welding processes.

Similarly, as shown in FIG. 3, the filling can be performed in situ, in that a second appliance, in particular a second welding appliance, very particularly a second laser 16, in the case of which material is additionally applied at the surface, makes it possible for the depression 28 formed by the re-melting by the welding appliance 13 to be directly subsequently filled—as long as the substrate 4 is still hot or has begun to melt at this point—by a build-up process, in particular by the application of a soldering process. The filling region 31 is considerably smaller than the re-melting region 25.

A crack 7 is thereby closed very quickly, without a complex and time-consuming oxide reduction of the defect 7 having to take place beforehand. So, oxide reduction is preferably not performed and usually would not be necessary.

As the material which fills the depression 28, it is possible to use a solder material, in particular a mixture of the base material (BM) of the substrate 4 and a solder material (lower melting temperature, at least 10 K) as the material of the substrate 4 or a pure solder material (lower melting temperature than BM, at least 10 K).

The process proposed here combines two already known processes in a novel manner. A first laser 13 is used to re-melt the crack 7, without addition of powder and without prior gas chemical cleaning of oxides. As a result, the crack 7 is closed and the oxide present in the crack is washed to the surface. It is preferable that a second laser 16 follows behind the first laser 13. Either pure high-temperature solder or else any desired mixture of high-temperature solder (difference in melting temperature ≧10 K) and base material powder is introduced into the second laser 16 through a nozzle located around the laser beam.

The energy input of the laser is in this case preferably chosen such as to ensure incipient melting of the component surface of the re-melting region 25. This incipient melting region is, however, considerably smaller than the re-melting region 25 and smaller than the filling region 31. As a result, firstly the oxide is washed to the edge of the molten pool, and secondly the powder is deposited. In the process, solder (or solder/BM) is applied in order to compensate for the loss in volume as a result of the re-melting (defective material on account of oxide!), and at the same time cracks which have formed as a result of the re-melting process are closed with the highly fluid solder. A new homogeneous surface is thereby formed. Preferably, an oxide removal treatment is not performed before re-melting.

The advantage lies in the secure closure of the main crack. Subsidiary cracks, which are occasionally formed by the re-melting process, are subsequently closed by the solder. The new cracks which are formed are, however, oxide-free per se and moreover small, and therefore the best preconditions for secure soldering are given.

A further advantage lies in the considerably reduced melting point of the powder additive for the filling. As a result, the laser power (and therefore the energy input into the substrate=>crack susceptibility) can be reduced, such that new cracks no longer arise in the component.

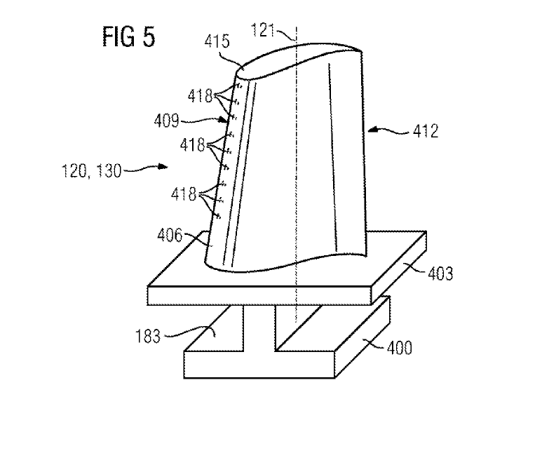

FIG. 5 shows a perspective view of a rotor blade 120 or guide vane 130 of a turbomachine, which extends along a longitudinal axis 121. A blade or vane are examples of a component that may develop a crack that should be repaired or filled, for example, by the apparatus and method disclosed herein.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403, a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949.

The blade or vane 120, 130 may in this case be produced by a casting process, also by means of directional solidification, by a forging process, by a milling process or combinations thereof.

Workpieces with a single-crystal structure or structures are used as components for machines which, in operation, are exposed to high mechanical, thermal and/or chemical stresses. Single-crystal workpieces of this type are produced, for example, by directional solidification from the melt. This involves casting processes in which the liquid metallic alloy solidifies to form the single-crystal structure, i.e. the single-crystal workpiece, or solidifies directionally. In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures). Processes of this type are known from U.S. Pat. No. 6,024,792 and EP 0 892 090 A1.

The blades or vanes 120, 130 may likewise have coatings protecting against corrosion or oxidation, e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1.

The density is preferably 95% of the theoretical density.

A protective aluminum oxide layer (TGO=thermally grown oxide layer) is formed on the MCrAlX layer (as an intermediate layer or as the outermost layer).

The layer preferably has a composition Co-30Ni-28Cr-8Al-0.6Y-0.7Si or Co-28Ni-24Cr-10Al-0.6Y. In addition to these cobalt-based protective coatings, it is also preferable to use nickel-based protective layers, such as Ni-10Cr-12Al-0.6Y-3Re or Ni-12Co-21Cr-11Al-0.4Y-2Re or Ni-25Co-17Cr-10Al-0.4Y-1.5Re.

It is also possible for a thermal barrier coating, which is preferably the outermost layer and consists for example of ZrO₂, Y₂O₃—ZrO₂, i.e. unstabilized, partially stabilized or fully stabilized by yttrium oxide and/or calcium oxide and/or magnesium oxide, to be present on the MCrAlX.

The thermal barrier coating covers the entire MCrAlX layer. Columnar grains are produced in the thermal barrier coating by suitable coating processes, such as for example electron beam physical vapor deposition (EB-PVD).

Other coating processes are possible, for example atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore preferably more porous than the MCrAlX layer.

Refurbishment means that after they have been used, protective layers may have to be removed from components 120, 130 (e.g. by sand-blasting). Then, the corrosion and/or oxidation layers and products are removed. If appropriate, cracks in the component 120, 130 are also repaired. This is followed by recoating of the component 120, 130, after which the component 120, 130 can be reused.

The blade or vane 120, 130 may be hollow or solid in form. If the blade or vane 120, 130 is to be cooled, it is hollow and may also have film-cooling holes 418 (indicated by dashed lines).

1. A process for re-melting and filling a defect in a surface of a substrate comprising:
re-melting the substrate at the defect for filling the defect filled by the re-melded material of the substrate, wherein a depression is formed by the re-melting at an outward side of the filled defect;
filling the depression which has formed using a soldering or welding process forming a filling region in the depression.

2. The process as claimed in claim 1, wherein the substrate which is re-melted comprises a metallic substrate.

3. The process as claimed in claim 1, wherein the re-melting is performed by a laser re-melting process.

4. The process as claimed in claim 1, further comprising:
the filling of the depression which has formed is filled by a build-up process.

5. The process as claimed in claim 1, further comprising, filling the depression immediately after the defect has been re-melted.

6. (canceled)

7. The process as claimed in claim 1, wherein the material for filling the depression comprises a mixture of a material of the substrate with a solder material which has a lower melting point than the material of the substrate.

8. The process as claimed in claim 1, wherein the defect in the substrate comprises oxides.

9. The process as claimed in claim 1, further comprising re-working the filling region.

10. The process as claimed in claim 1, further comprising removing the oxides after the re-melting process.

11. A component comprising a substrate with a defect in a surface of the substrate having a re-melted region and a soldered region in and at the defect.

12. The process as claimed in claim 1, wherein the process for filling the depression is a soldering process.

13. The process as claimed in claim 2, wherein the metallic substrate comprises a nickel-based or cobalt-based substrate.

14. The process as claimed in claim 4, wherein the build-up process is a laser build-up process.

15. The process as claimed in claim 7, wherein the melting point of the solder material has a lower melting point of at least 10 K than the melting point of the substrate.

16. The process as claimed in claim 7, further comprising not subjecting the defect to oxide removal treatment before the re-melting.
